(19) United States
(12) Patent Application Publication
(10) Pub. No.: US 2026/0057690 A1
(43) Pub. Date: Feb. 26, 2026

(54) METHOD AND SYSTEM FOR COUNTERFEIT DETECTION

(71) Applicant: Nawaf Nasser ALJARBOA, Riyadh (SA)

(72) Inventor: Nawaf Nasser ALJARBOA, Riyadh (SA)

(21) Appl. No.: 18/811,387

(22) Filed: Aug. 21, 2024

(51) Int. Cl. G06V 30/41; G06Q 30/018; G06V 10/77; G06V 30/16

(52) U.S. Cl. CPC G06V 30/41; G06Q 30/0185; G06V 10/7715; G06V 30/16

(57) ABSTRACT

A method of authenticating a label for anti-counterfeiting detection is provided. The method comprises receiving a digital image of a label from an image capturing device, extracting features of one or more patterns comprised by the digital image, applying a trained pattern recognition algorithm to decipher the one or more patterns in the label, and returning an authenticity of the label. A corresponding system comprising an image capturing device and a processor configured to execute the method is provided as well.

### TECHNICAL FIELD

The present disclosure herein relates to methods and systems of counterfeit detection based on an image of a label that is associated with obscure patterns.

### BACKGROUND

Counterfeiting is a global problem, that fuels the underground economy, and often linked to organized crime networks and illicit activities, including money laundering, terrorism financing, and trafficking. There exists a widespread requirement to validate the authenticity of a broad range of items including currency and official documents to consumer goods labels such as for example pharmaceuticals, and electronics. Various systems and methods for authenticating such items have been described (WO 2015/052181 A1, US 2009/0008924 A1, WO 2008/143087 A1, FR 3070082 A1, WO 2017/024779 A1, U.S. Pat. No. 9,863,920 B2, U.S. Pat. No. 9,919,512 B2).

The evolution of technology not only facilitates the development of advanced security measures against counterfeiting but also enables the emergence of sophisticated counterfeiting techniques at a reduced cost, that is capable of closely mimicking genuine labels or documents. This proportional relationship is ongoing, and thus it is desirable to have improvements in existing methods.

### BRIEF SUMMARY

According to a first aspect of the disclosure, a method of authenticating a label for anti-counterfeiting detection is provided. The method comprises receiving a digital image of a label from an image capturing device, extracting features of one or more patterns comprised by the digital image, applying a trained pattern recognition algorithm to decipher the one or more patterns in the label, and returning an authenticity of the label.

In some embodiments, the method further comprises preprocessing the digital image before extracting features. In some further embodiments, preprocessing comprises at least one of image standardizing, image color space transformation, image contrast enhancement, image spatial transformation, image segmentation and image refinement of the digital image. In yet further embodiments, the features of the one or more patterns comprise at least one of edge properties, textural properties, frequency properties, and line properties.

In some embodiments, extracting features comprises at least one of dividing the digital images into image patches, applying one or more filters to extract the features, reducing the size or dimensions of the filtered patch images, generating an encoded matric with informative pattern features, and concatenating the encoded matrix with the image features matrix as input for the trained pattern recognition algorithm. In some further embodiments, the pattern recognition algorithm is obtained via training a comprehensive original deep learning model for deciphering the one or more patterns, wherein the comprehensive original model is further used to train a compressed deep learning model to mimic the behavior of the original model for deciphering the one or more patterns. In yet further embodiments, the pattern recognition algorithm is obtained via a dual stage deep learning pipeline by training a first model to generate training data, refining the generated training data, training a second model with the refined generated training data for deciphering the one or more patterns.

According to a second aspect, a corresponding system comprising an image capturing device and a processor configured to execute the method is provided. According to a third aspect, a corresponding computer program product is provided.

### BRIEF DESCRIPTION OF THE DRAWINGS

FIG. 1 is a flow diagram of a method of authenticating a digital image according to the disclosure.

FIG. 2 is a flow diagram of a method of preprocessing the digital image of the label.

FIG. 3 is a flow diagram of a method of processing the digital image of the label.

FIG. 4 is a flow diagram of a method for obtaining the pattern recognition algorithm.

FIG. 5 is an exemplary decision tree model.

FIG. 6 is an exemplary deep learning model.

FIG. 7 is an exemplary compressed deep learning model according to one embodiment.

FIG. 8 is a flow diagram of a method comprising of a deep learning pipeline of dual models to obtain the pattern recognition algorithm, according to another embodiment.

FIG. 9A is an exemplary training model in the deep learning pipeline.

FIG. 9B is a flow diagram of a method of post processing the generated training data.

FIG. 9C is an exemplary pattern recognition model in the deep learning pipeline.

FIG. 10 is a flow diagram of a method of evaluating a test sample via the trained pattern recognition algorithm.

FIG. 11 is a functional block diagram of an anti-counterfeiting detection system of authenticating a label.

FIG. 12 is a sematic drawing of an anti-counterfeiting detection system of authenticating a label, according to another embodiment.

### DETAILED DESCRIPTION OF THE INVENTION

In numerous of industry sectors and practical applications, there exist a widespread requirement to validate the authenticity of a broad range of items including currency, official documents, financial documents, labels, and others in a manner that is efficient, cost-effective, and provides a high accuracy. It has been observed over years, that there is a tradeoff between the level of security incorporated in a label or a document etc. in terms of accurate detection, e.g. effectiveness in forgery prevention, and the scalability of the detection method in terms of cost of implementation and convenience of usage. The present disclosure provides anti-counterfeiting methods and systems that may be used directly on site and in combination with various devices (e.g. digital camera of a mobile device) to detect and determine the authenticity of the item in a cost-effective way. The disclosure herein may be used in association with graphical designs such as for example logos or geometrical shapes, or the like. The graphical designs may contain obscure patterns such as for example lines, dots, symbols, or any other patterns.

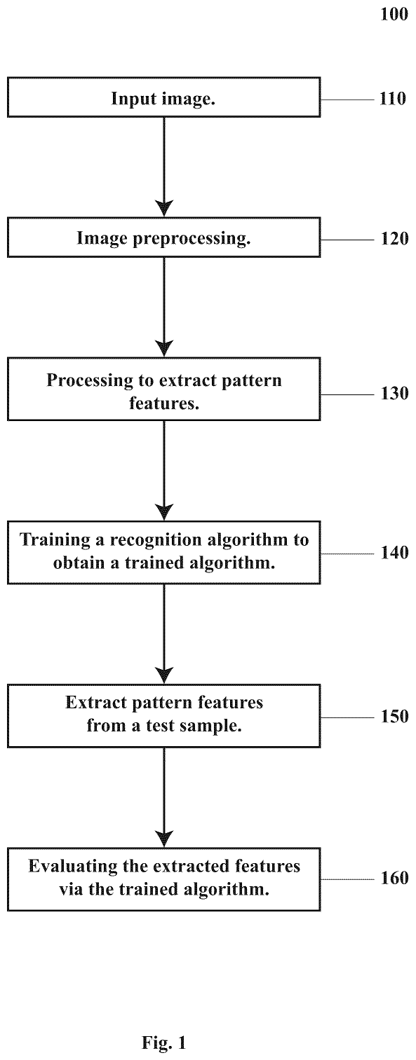

FIG. 1 illustrates a method of training and applying a pattern recognition algorithm for determining authenticity an image of a label. At 110, one or more sample images of a label are provided, e.g. to a processor. The sample images may include a set of authentic samples, i.e. images of the authentic label, and a set of counterfeited samples, i.e. images of counterfeited labels (of the authentic label). The sample images may be captured by any suitable device, such as for example a standalone digital camera or the digital camera of a mobile device. The size of a captured image may be in a wide range, for example from 300×300 pixels to about 3000×3000 pixels. The captured image or images may be in any format known in the art, e.g. BMP, TIFF, PNG, JPEG, etc. The method then proceeds to 120. At 120, the sample images may be preprocessed by the processor. For example, preprocessing may be used to standardize the image, remove artifacts, refine the image(s) to reduce the computational complexity, and increase the performance in the following steps. At 130, the preprocessed image(s) are processed by the processor to extract pattern features. These feature patterns may be, for example, edge properties, textural properties, frequency properties, line properties, and many others.

At 140, a pattern recognition algorithm may be trained by using training data (e.g. patterns of extracted features, sets of labeled sample images) to obtain a trained pattern recognition algorithm. The pattern recognition algorithm described herein may refer to a computer implemented method or model or algorithm, which may be used to detect and decipher the pattern within a label sample to identify the authenticity of the label sample. The input to the algorithm may be one or of an image of a label sample that contains one or more hidden patterns, or the extracted pattern features, and the output may be the deciphered representations that identifies the label sample. The deciphered representation herein may refer to a security code, which may comprise, for example, but not limited to, characters, symbols, numerals, etc. The deciphered representation may resemble a serial number, manufacture code, production date, etc.

The pattern recognition algorithm may include one or more of an Haar cascade algorithm, a K-means clustering, a Watershed algorithm, a graph-based segmentation algorithm, deep learning models, a random forest, a logistic regression, an histogram-oriented gradient-based algorithm, Support Vector Machines, and the like. The pattern recognition algorithm may be trained on training data (e.g. pattern extracted features, set of images) to determine the parameters of the model. By training the algorithm, the necessary model parameters for the algorithm are determined to obtain the pattern recognition algorithm.

At 150, the pattern features are extracted from one or more digital images of a label sample to be tested, i.e., analyzed for authenticity. This label sample to be tested may be authentic sample or counterfeited sample—this may not be known. The extracted features of the label sample are extracted similar to the method 120, which will be described further below. At 160, the method evaluates the extracted features via the trained algorithm to evaluate the authenticity of the label in the test sample.

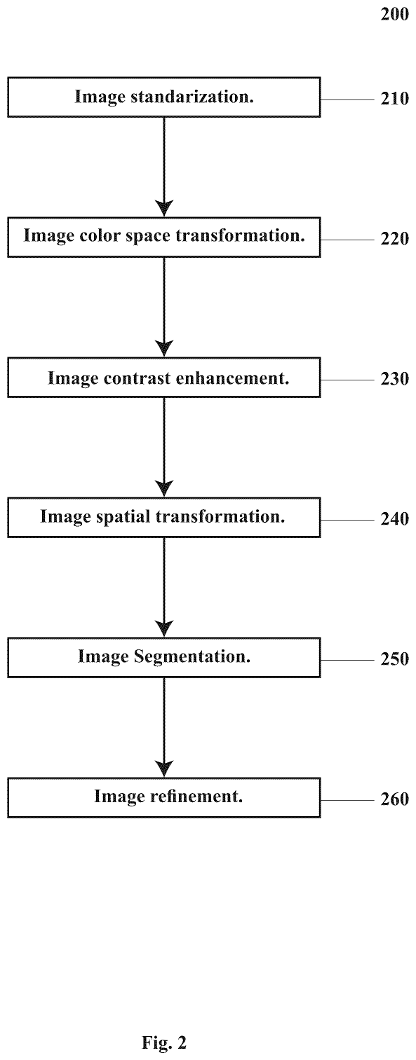

FIG. 2 illustrates an example method of preprocessing an input image to optimize the feature extraction process, e.g. the preprocessing 120 for process 130 in FIG. 1. At 210, the input image may be standardized which may involve resizing the input image into a predefined size M×N while preserving its ratio (e.g. 940×940, 560×560, etc.). Moreover, the pixel values may be normalized to a certain distribution, such as (0,1), to ensure consistency in input size. At 220, the color space of the input image may be converted to another mode (e.g. from RGB to LAB) to accurately analyze color to reduce the impact of illumination variation. At 230, the contrast of the input image may be enhanced using enhancement techniques (e.g. histogram equalization) to improve the visibility of fine details especially with low contrast or uneven illumination. At 240, the input image may be spatially transformed using operations, such as translation, rotation, and scaling, to correct geometrical distortion and further enhance the input image. At 250, the input image may be segmented using thresholding techniques (e.g. global thresholding, binary thresholding, adaptive thresholding, etc.). For example, adaptive thresholding may be applied on the input image, in which each pixel value may be compared to the average intensity of its neighboring pixels and may be set to a high value if the pixel value exceeds a locally computed threshold or, if not, to a low value. This allows for better adaptation to variation in lightning conditions or image gradient. At 260, an optional refinement step may be applied to the segmented image. This refinement step may help clean up edges and impurities such as holes or gaps. This include operations for example erosion or dilation. This may be effective in refining the input image and remove unwanted artifacts.

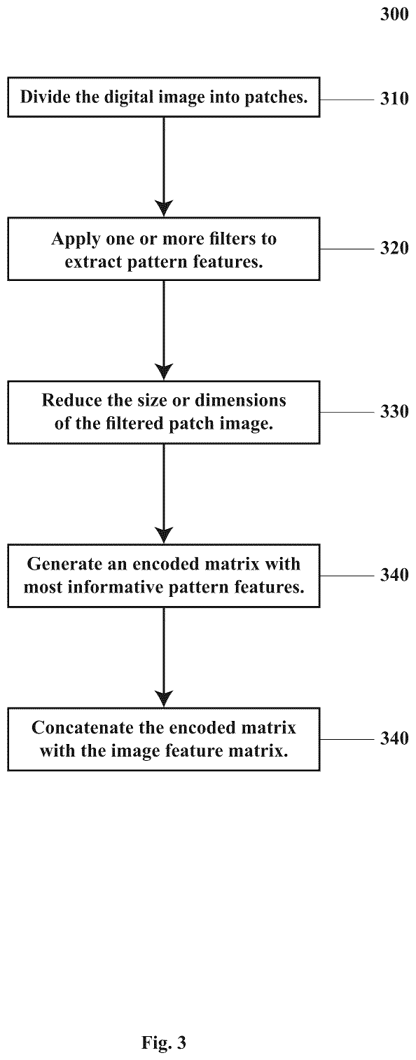

FIG. 3 illustrates the method of processing the digital image to extract patterns features, e.g. like the processing 130 in FIG. 1. At 310, the input image may be divided into non-overlapping patches with predefined size M×N. A suitable patch size may be selected based on spatial resolution and computational complexity needed, supported by the processing, or flexibly defined by a user (e.g. 8×8 pixels, 16×16 pixels . . . etc.). The number of patches may range, for example, from 1-6000 depending on an input image size, computational resources available, etc. Each patch Pᵢⱼ is a sub-image of I, where i and j donates the patch indices. Then at 320, one or more filters are applied to each patch Pᵢⱼ to extract features within each patch image to obtain one or more feature vectors per patch. Those extracted features reflect information about the pattern, such as for example edge features, textural features, frequency features, lines features, size, intensity, orientation, arrangement, and the like.

In one embodiment, multiple filters may be applied sequentially to each patch image to extract information about the pattern(s) using Canny edge detector followed by Hough transform feature extraction. The Canny edge algorithm may be applied to each patch Pᵢⱼ to highlight the edges of the patterns and obtain filtered binary patches. For example, by detecting areas with high gradient magnitude filtered binary patches EPᵢⱼ are determined with edges being marked by 1. For example, a low and high threshold are set to determine the minimum gradient required for a pixel to be considered as a potential edge pixel or strong edge pixel. The gradient magnitude may be determined by convolving each patch Pᵢⱼ with a pair of filters (e.g., Prewitt operator) in the horizontal and vertical direction and combining them to obtain filtered patches EPᵢⱼ. For example, the gradient magnitude may be computed as follows:

$$Gradient Magnitude = \sqrt{{G ( x )}^{2} + {G ( y )}^{2}} \qquad ( 1 )$$

Then, each pixel in the filtered patches EPᵢⱼ may be transformed via the Hough transform into the parameter space P(ρ, θ), represented as an accumulator array A[i, j]. In this space, each A[i, j] counts the occurrences of potential patterns with parameters corresponding to specific ρ, θ values. Where ρ is the distance and θ is the angle. The values accumulated in the accumulator array A[i, j] are transformed into a single dimensional feature vector vᵢⱼ for each patch image Pᵢⱼ.

$${v}_{ij} = [ A [ 1 , 1 ] , A [ 1 , 2 ] , … , A [ 1 , M ] , A [ 2 , 1 ] , … , A [ N , M ] ] \qquad ( 2 )$$

Where N represents the total number of bins for ρ, and M represents the total number of bins for θ. It is to be understood that any suitable filters may be used to extract information about the pattern features, for example, Canny edge filters, Sobel filters, Hough Transform, Wavelet transform, Directional filter banks (DFB), Laplacian filters, Gaussian filters, Prewitt filters, band-pass filters, low-pass filters, and the like.

At 330, the feature vector vᵢⱼ for each patch image Pᵢⱼ may be reduced to remove redundant information, and retain most relevant features for more efficient analysis using techniques such as binning or clustering. In one embodiment, a binning technique may be used, for example, such that the accumulator array A[i, j]θ is organized into larger aggregated bins by summing the accumulator values from groups of smaller bins to form each larger bin Bᵢⱼ [K] that forms the reduced feature vector V_{reduced,ij} for each patch Pᵢⱼ. Each element in the reduced feature vector V_{reduced,ij} (e.g. Vᵢⱼ₁, Vᵢⱼ₂, . . . , Vᵢⱼₖ) corresponds to specific bin Bᵢⱼ [K], where K is the number of bins.

Another exemplary technique may be used is, for example, a clustering technique, where each significant accumulator value in A[i, j], which represents potential parameter (ρ, θ), may be treated as points in feature space. These points are clustered into K groups, and the centroids of these clusters indicate the most informative features, which form the reduced feature vector vᵢⱼ for each patch Pᵢⱼ (e.g. V_{ijf}, Vᵢⱼ₁, . . . , Dᵢⱼₖ). At 340, the feature vector V_{reduced i,j} for each patch may be combined to form a single image matrix F (e.g. V₁, V₂ . . . , Vₙ) of dimensions n×d, where n is the number of patches (rows and columns i, j) and d represents the number of features in each vector. Each row i in the matrix represents a feature vector for the ith patch.

At 350, an encoded matrix with the (most) essential features of the feature matrix F may be generated by mapping the feature matrix F to a lower dimensional matrix E, which serves as compact encoding of the most important features in the original matrix F. For example, any transformation technique may be used (e.g. Linear Discriminant Analysis (LDA), t-distributed Stochastic Neighbor Embedding (t-SNE), Principle Component Analysis (PCA), etc.) to map the feature matrix F of dimensions (n×d) obtained at 340 to a lower dimension matrix. For example, Principle Component Analysis (PCA) may be used to generate the encoded matrix by mapping the feature matrix F of dimensions (n×d) to a lower dimensional matrix E. For example, each feature in the matrix F may be scaled to have a zero mean, and a unit variance to avoid distortions that may arise from differences in the original scales of the feature matrix. The standardized feature matrix may then be projected into a space defined by the eigenvectors of the covariance matrix. The eigenvectors with the highest eigenvalues may then be selected to form the eigenvectors matrix Vₖ of dimensions (d×k), with k being the dimension of the encoded matrix. The standardized feature matrix F_{std} may then be transformed to the eigenvectors matrix Vₖ by multiplication to obtain the encoded matrix E of dimensions (n×k); Each row Eᵢ in the matrix E (e.g. e₁, e₂, . . . , eₙ) is the embedding vector for the ith patch image.

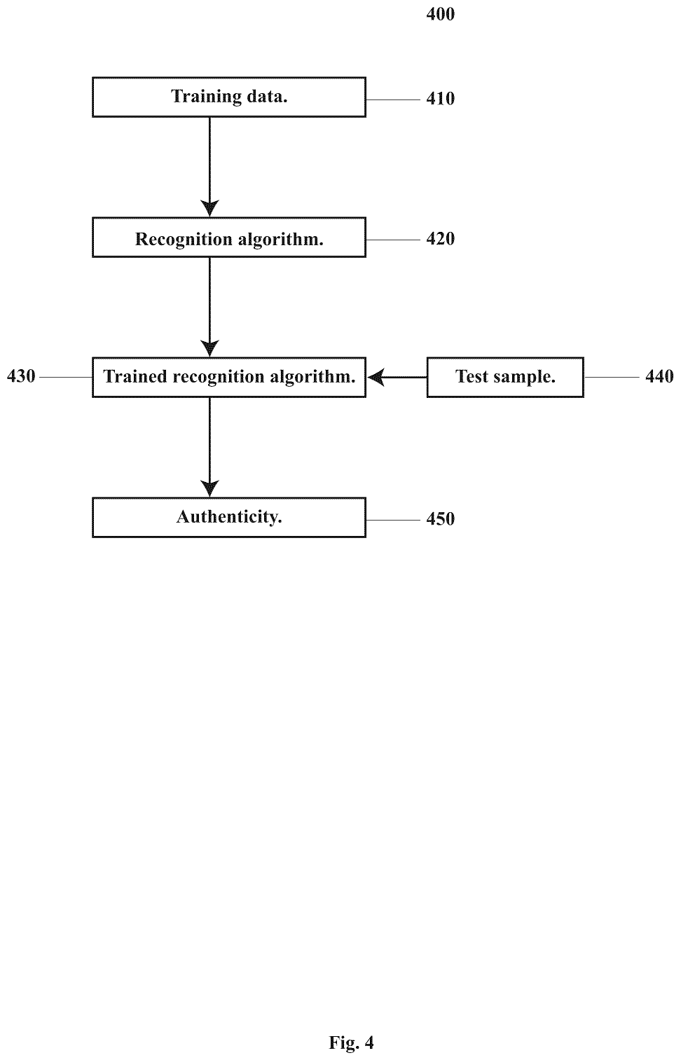

At 360, the encoded matrix E may be concatenated with the image feature matrix F to obtain a comprehensive enriched feature matrix F_{E}_{ᵢ} of dimensions n×(d+k). The result may be applied as training data to train the pattern recognition algorithm to obtain a trained pattern recognition algorithm. FIG. 4 illustrates a method of obtaining the pattern recognition algorithm, e.g. the training as depicted in 140 of FIG. 1.

At 410, the training dataset may include one or more of a set of annotated images (e.g. pixel level annotation of pattern location), a set of labeled data (e.g. patterns corresponding representations), and the pattern extracted features. The labeled data may include, for example, characters, numerical numbers, text, symbols, and the like. Each labeled data set may be encoded as a binary vector where only one element is 1 and the rest is 0, where 1 indicates the presence of the corresponding representation or pattern, respectively. The images in the training dataset may also contain images that simulate real word conditions, such as images with added noise. The training dataset may contain distorted images, such as images that are scaled rotated, or flipped. The training dataset may contain damaged images such as for example images with damaged texture. The training dataset may contain images captured in less ideal photographic conditions, such as images captured with various lightning conditions including low light, poor focus, or images with manipulated effects including brightness, saturation, and contrast. The training dataset may contain images with various backgrounds to reduce the risk of overfitting.

At 420, a suitable algorithm may be selected for pattern recognition. This may include one or more for example, one or more of a Haar cascade, a K-means clustering, a Watershed algorithm, a Gaussian Mixture Models (GMM), a graph-based segmentation algorithm, Gradient Boosting Machines (GBM), deep learning models, a random forest, a logistic regression, an histogram-oriented gradient-based algorithm, Support Vector Machines, etc.

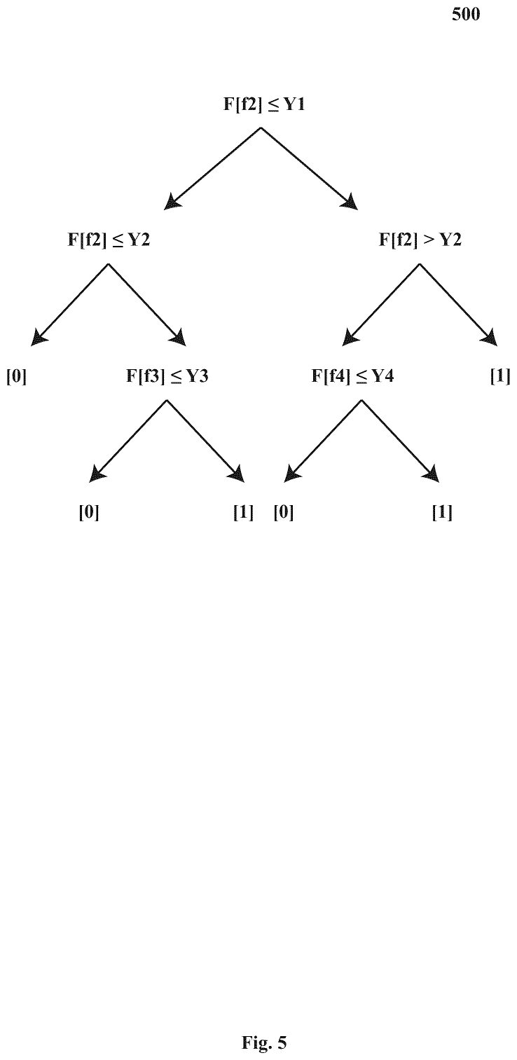

FIG. 5 illustrates an exemplary decision tree model, which may be used as pattern recognition algorithm. The training data (e.g. the feature matrix F_{E} of dimensions n×(d+k)) may be provided by the method as described with respect to FIG. 3, and used as input to train the model with labeled data (e.g. n×1) to determine the parameters of the model. With the determined parameters, the trained decision tree model may be obtained.

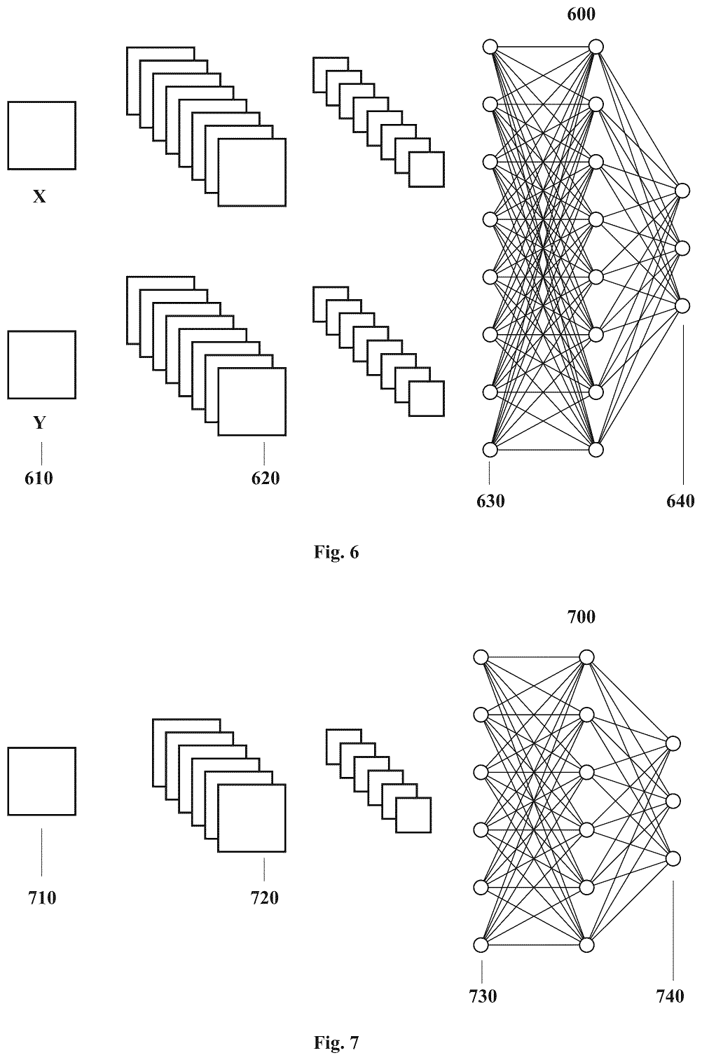

FIG. 6 illustrates an exemplary deep learning model that is designed with a spatial attention layer. At 610, the training dataset (e.g. pixel level annotated images of pattern location, extracted pattern features) are applied as input to train the model with labeled data to determine its parameters, which will be described further below. The model may be configured to have separate channel pathways (e.g. convolutional layers) for different input types. For example, one channel receives the annotated images I_{annotated}, while the other receives the extracted pattern features F_{E} provided by the method of 300.

At, 620 each input may be passed to separate pathways of convolutional layers. For example, the annotated images I_{annotated} may be passed to the branch layers X, of convolutional operations (e.g. activation function, Pooling) of learnable kernels; while the extracted pattern features F_{E} may be passed to the branch layers Y of convolutional operations (e.g. Activation function, Pooling) of learnable kernels. The attention layer A may be placed in the branch layers X between the convolutional layers to modulate the feature map F_{(I}_{_{annotated}}₎ by emphasizing attention on important spatial locations in the feature maps and de-emphasizing less important ones. This may be done by assigning scores to more important areas, and lower scores to less important areas. For example, the attention layer A receives the feature map F_{(I}_{_{annotated}}₎ and computes the attention map A_{(F}_{_{(Iannotated)}}₎ (e.g. matrix of scalar values of dimensions (h×w)). Each element aᵢⱼ in the attention map A(F_{(I}_{_{annotated}}₎) corresponds to a spatial location within the feature map F_{(I}_{_{annotated}}₎, and the value of each element (e.g. between 0 and 1) indicates the required attention to each location within the feature map. This may be represented as follows:

$$A ( {F}_{( {I}_{annotated} )} ) ∈ {h \times w}^{} where each {a}_{ij} ∈ [ 0 , 1 ] \qquad ( 3 )$$

The attention map A(F_{(I}_{_{annotated}}₎) modulates the feature map F(I_{annotated}) by element-wise multiplication to obtain the modulated feature map F_{M} of dimension (h×w). At 630 the feature maps from both branches are merged, where one or more regularization techniques (e.g. batch normalization, dropout, etc.) may be added to stabilize training. At 640, the final layer outputs the probabilities of pattern representations, which will be described further below.

During training, a unified loss function may be used to measure the discrepancy between the output and the ground truth, taking into consideration the accuracy of the attention, the accuracy of pattern recognition, in terms of detecting the patterns, and deciphering. For example, one or more suitable loss functions may be used (e.g. entropy loss, focal loss, generalized intersection over union loss, mean squared, etc.), and combined to account for the attention loss, detection loss, and deciphering loss. The combined loss function may be represented as follows:

$$Loss = {λ}_{Atten} {Loss}_{Atten} {λ}_{detect} {Loss}_{detect} + {λ}_{decipher} {Loss}_{decipher} \qquad ( 4 )$$

where, λ_{Atten}, λ_{detect}, λ_{decipher} are weights that balance the contribution of each loss component to the overall loss function. A suitable optimizer may be used (e.g. Adam, RMSprop, Stochastic Gradient Decent (SGD), etc.) to minimize the combined loss functions and obtain the parameters of the model. The trained algorithm may then be obtained.

In some embodiments, an optional step may be added to improve the efficiency of the algorithm by compressing the model into a smaller version which may reduce the computational load during inference. The knowledge learned by the original, more comprehensive model (e.g. of determining the optimal parameters to recognize the pattern) may be transferred to a new model that is smaller than the original model (e.g. with less channels, parameters, layers, etc.).

For example, the new model may be trained to predict the same output as the original model while passing the same input to both models and measuring the discrepancy between their output prediction compared to the labeled data. The smaller model may be configured to have a single input channel to process one type of input at a time. The training data (e.g. extracted pattern features, annotated images etc.) may be fed to the original model, while the smaller model may be fed one type of input in each iteration (e.g. either extracted pattern features or the annotated images). FIG. 7 is an exemplary design of the compressed model.

At 710, the input channel receives the training data (e.g. extracted pattern features, the annotated images etc.). Based on the type of input received, the convolutional layer pathway for that type of input gets activated using suitable activation function (e.g. Sigmoid, tanh, ReLU, SoftMax, etc.). At 720, a series of convolutional layers (e.g. learnable kernels) are applied to the input training data followed by subsequent shared layers 730 of convolutional operations (e.g. activation function, pooling etc.) where one or more regularization techniques (e.g. batch normalization, dropout, etc.) may be added to help stabilize training. At 740, the final layer of the model outputs the raw scores of the pattern representations. The final layer in both models (e.g. the trained model described in FIG. 6, and the compressed model) are adjusted to have the same normalized function that converts the raw scores of the prediction to a probability distribution between 0 and 1. For example, a SoftMax function may be used, represented as follows:

$$Softmax ( {z}_{i} , τ ) = \frac{{e}^{\frac{{z}_{i}}{τ}}}{{\sum }_{j = 1}^{k} {e}^{\frac{{z}_{j}}{τ}}} , where τ > 1 \qquad ( 5 )$$

where zᵢ is the raw score for the ith representation, and t is the probability smoothing term. This allows the compressed model to understand not only the predicted class, but also the entire probability distribution of the trained model including the likelihood of incorrect classes. The compressed model may be trained using batches of training data (e.g. extracted pattern features, annotated images etc.). At each training iteration, the same batch may be provided as input to both models. For example, the trained original model with dual inputs receives two types of inputs, while the compressed model receives only one type of input at each iteration. The compressed model may be trained to determine the necessary parameters to have the same output predictions as the trained original model. The parameters of the compressed model are determined by measuring the discrepancy between the output of both models (the trained model and the compressed model) compared to the labeled data using a universal loss function. For example, suitable loss functions may be selected (e.g. cross-entropy, KL divergence, etc.) to account for each loss component and combined as follows:

$$Loss = {λ}_{1} {Loss}_{Output} + {λ}_{2} {Loss}_{True representation} \qquad ( 6 )$$

where λ₁, λ₂ are weights that balance the contribution of each loss component to the overall loss function. A suitable optimizer may be used (e.g. Adam, RMSprop, Stochastic Gradient Decent (SGD), etc.) to minimize the combined loss function to obtain the parameters of the compressed model. The trained pattern recognition algorithm may then be obtained as compressed model.

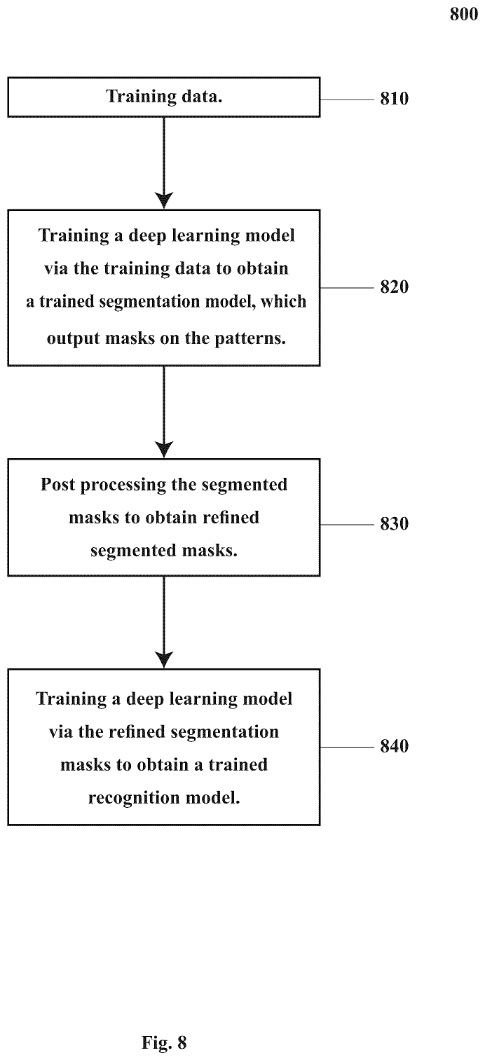

In one embodiment, the trained pattern recognition algorithm may be obtained via a deep learning pipeline comprising two models, a training model and a pattern recognition model. The training model may be trained using the training data (e.g. pixel level annotated images of pattern location, pattern extracted features etc. as explained above) with labeled data to output segmentation masks on the patterns. Segmented masks may be generated and then passed to a post-processing line to be refined to obtain refined segmented masks. The refined segmented masks may then be used as input to train the pattern recognition model to obtain a trained pattern recognition model. The models in the pipeline may be trained either separately or simultaneously, which will be described further below. FIG. 8 illustrates a method comprising of a deep learning pipeline to obtain the pattern recognition algorithm, according to one embodiment.

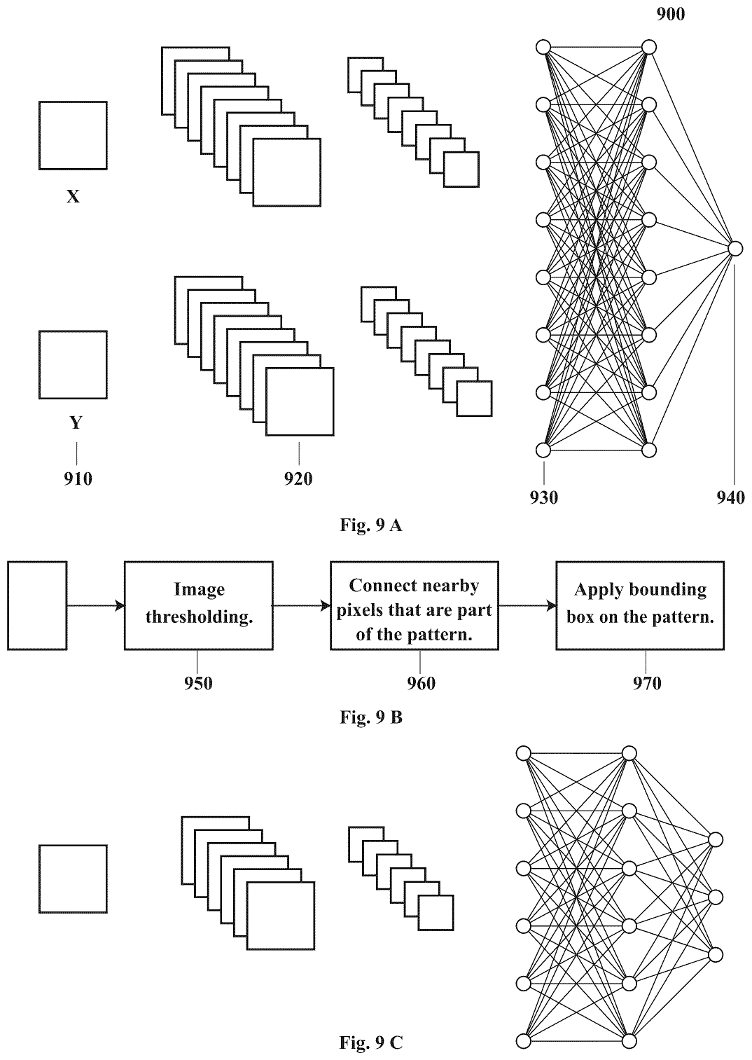

At 810, the training dataset (e.g. pixel level annotated images of pattern location, pattern extracted features etc.) may be applied as input to train the training model to determine the parameters to obtain a trained training model 820. The output may be segmented masks, with patterns within the images being isolated from the background. Before discussing the training further, details of a possible training model can be found in FIG. 9A, which shows an exemplary design of the training model.

At, 910, the training dataset (e.g. pixel level annotated images of pattern location, extracted pattern features etc.) are applied as input to train the first model to determine its parameters. At 920, each type of input may be passed to separate pathways of convolutional layers. For example, the annotated images I_{annotated} may be passed to the branch layers X of convolutional operations (e.g. activation function, pooling) of learnable kernels, while the extracted pattern features F_{E} may be passed to the branch layers Y of convolutional operations (e.g. activation function, pooling) of learnable kernels. At 930, the feature maps from both branches may be merged, where one or more regularization techniques (e.g. batch normalization, dropout, etc.) may be added to stabilize training. At 940, the final layer may output the segmented masks. For example, each pixel may be mapped to a probability distribution between 0 and 1, where a pixel value closer to 1 indicates the pixel is part of the pattern and a pixel value closer to 0 indicates otherwise. The obtained segmentation masks may be further processed and refined to be used as input to train the second model in the pipeline.

Referring back to FIG. 8. At 830, post-processing may be applied to the generated segmented masks images obtained at 940 to obtain refined segmented masks that may be used as input to train the recognition model at the second stage of the pipeline, which is illustrated further by FIG. 9B, which shows a method of post-processing the generated training data. At 950, the obtained segmentation masks 940 may be using any thresholding technique to covert the probabilities of the pixels to binary representations (e.g. 0, 1), where any value above the threshold may be considered to be a part of the pattern. At 960, neighborhood-pixels that are part of the pattern may be connected to form a distinct pattern using, for example, connected components, where nearby pixels with the same values are connected to form a distinct pattern. At, 970 a bounding box may be applied to each distinct pattern to obtain the refined segmented masks 830 of FIG. 8. The obtained refined segmented masks 830 may be used as input to train the pattern recognition model to obtain the trained pattern recognition model 840. FIG. 9C is such an exemplary design of the pattern recognition model.

The models in the pipeline may be trained either separately or simultaneously. For example, the models in the pipeline may be trained simultaneously to determine the parameters of the models. Each training iteration includes providing the training model with the training data (e.g. extracted pattern features, annotated images) to determine the parameters to output segmented masks, where the patterns within the images may be isolated.

The obtained segmented masks may then be passed to the post-processing line to obtain refined segmented masks, that may be passed to the recognition model to determine the parameters to output the predicted representations of the patterns. During each iteration a unified loss function may be used to measure the discrepancy between the output, and the ground truth, taking into consideration the accuracy of isolating the patterns by the segmented masks, and the accuracy of pattern recognition, in terms of detecting the patterns, and deciphering. For example, suitable loss functions may be used (e.g. entropy loss, generalized intersection over union loss, mean squared, etc.) and combined to account for isolation loss, detection loss, and deciphering loss. The combined loss function may be represented as follows:

$$Loss = {λ}_{isolation} {Loss}_{isolation} + {λ}_{detection} {Loss}_{detection} + {λ}_{decipher} {Loss}_{decipher} \qquad ( 7 )$$

where λᵢₛₒₗₐₜₑ, λ detect, λ decipher are weights that balance the contribution of each loss component to the overall loss function. A suitable optimizer may be used (e.g. Stochastic Gradient Decent (SGD), Adam, etc.) to minimize the combined loss function and obtain the parameters of the models in pipeline. The trained algorithm may then be obtained 850.

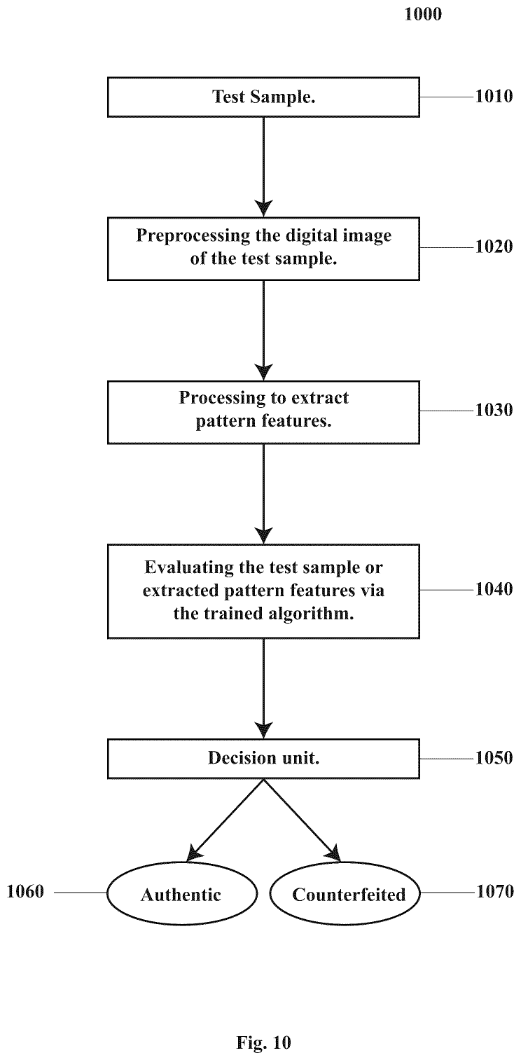

Referring back to the method of 400, a test sample 440 (e.g. extracted features, image etc. as described above) may be evaluated by the trained algorithm 430 to determine the authenticity of the sample 450, for example, since either the sample is authentic or counterfeited but this is not known. This determination process is described in FIG. 10.

FIG. 10 illustrates a method of evaluating a test sample via the trained algorithm. At 1010 a digital image of the test sample image may be provided. At 1020, the digital image of the test sample may be preprocessed to standardize the image, remove unwanted noise, and refine the image similar to the method of 100. At 1030, the preprocessed image may then be processed to extract pattern features similar to the method of 200 to obtain an encoded feature vector F_{E} of the test sample, that may be passed to the trained algorithm to be evaluated. In some embodiments the encoded feature vector F_{E}, or the preprocessed image, or both may be passed to the trained algorithm to be evaluated. At 1040, the trained algorithm output the probability (e.g. between 0 and 1) indicating the likelihood of the pattern representations. The representation with the highest probability may be selected. The method then proceeds to 1050, where a decision unit may receive the predicted output from the algorithm. If the probability is above certain threshold, the sample may be determined to be authentic 1060, otherwise it may be determined to be counterfeited 1070.

In some embodiments, if the probability is above certain threshold, the decision unit may check a database for an already present record. The database may be a centralized or decentralized database. The database may be a relational database system, non-relational database system or a mix of those database systems. The database may comprise volatile and non-volatile memory, multi-level cell flash memory, triple level cell flash memory, and/or cloud storage. It should further be appreciated that the database described herein may be a combination of multiple storage resources, including but not limited to those referenced herein. The database may further include different storage technologies and/or may be distributed to multiple locations.

In some embodiments, a blockchain may be used as database, where the predicted output is hashed using a cryptographic hash function (i.e. SHA-256, etc.) and compared to hashed pattern representations in the database. If the hashed pattern representation does not match a record in the database, this means that the sample has not been previously detected. Therefore, the sample may be determined to be authentic 1060 and a new transaction may be added to the blockchain, recording the hash of the deciphered pattern, timestamp, and other relevant data to ensure tamper proof record. In another embodiment, if a record has been found in the database, the sample may be determined to be counterfeited 1070.

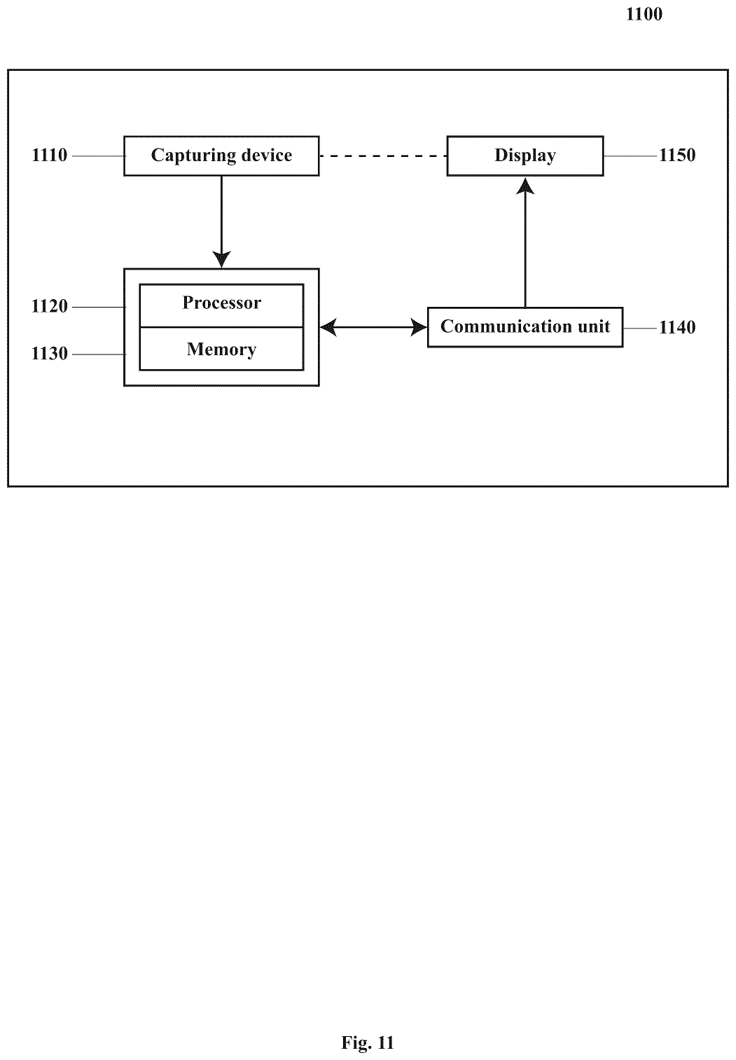

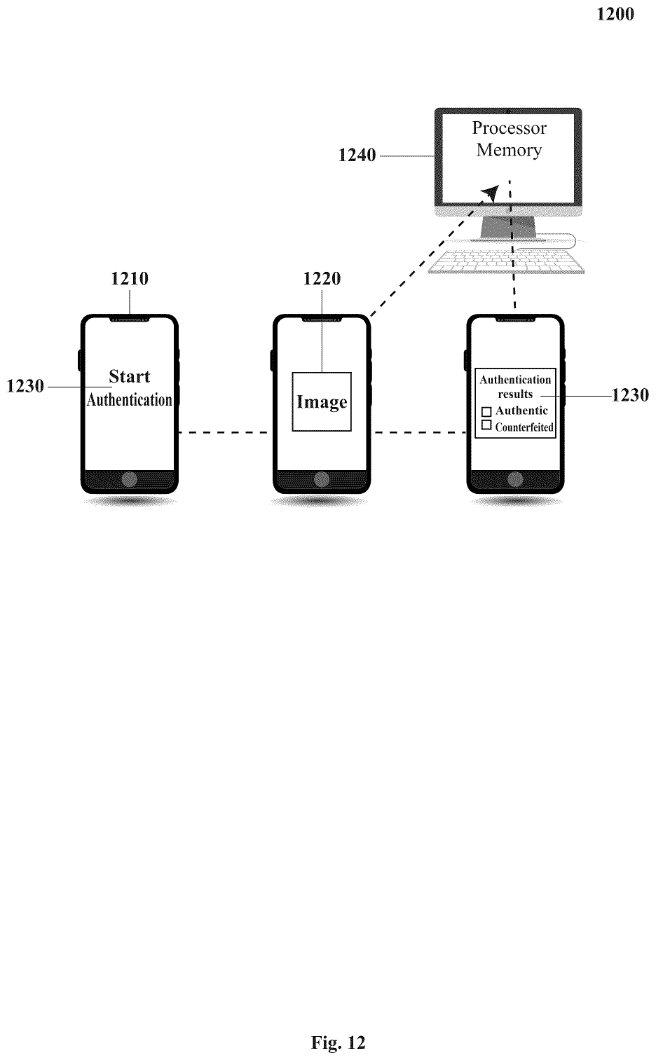

FIG. 11 illustrates a system of authenticating a label that contains patterns by implementing one or more methods described herein. The system may include one or more of a capturing device 1110, a memory 1120, a processor 1130, communication unit 1140, and a display screen 1150. The capturing device 1000 may be configured to capture the image of the label. The capturing device may be a digital camera. In some embodiments the capturing device may include a digital camera of a mobile device. The memory 1120 may be composed of image storage unit to store the captured images and algorithm storage unit to store the algorithm. In some embodiments, the memory may have additional storage units, for example, an instructions storage unit, which stores the instructions for performing the methods, or a training data storage unit, which stored the training data. In some embodiments, the training data, the pretrained algorithm and/or any other software component or data described herein may be stored in the memory 1120. In some further embodiments, the pretrained algorithm may be trained using the processor 1130 and applying the methods described above. The processor 1130 may be connected to the capturing device. The processor 1130 may receive the captured image 1110, preprocesses it, and processes it to extract pattern features by the method of 100, and 200.

In some embodiments, the training data may be processed by the processor to train the recognition algorithm by the method of 300. The trained algorithm may be stored in the memory 1120 and may be used by the processor to evaluate label image sample to determine whether the label image is authentic or counterfeited. The final decision may be made by the processor by checking if the predicted representation is above certain threshold or not. The authentication output may then be shown in the display screen 1150. The display screen 1150 may be associated with a user interface, that is configured to receive information from a user. For example, to start the authentication process, the user interface may guide the user through the authentication process and output information to a user. For example, the user interface may display the result of the authentication process.

In some embodiments, the capturing device 1110, may be a digital camera of a mobile device, e.g., a mobile phone or table or the like, that may wirelessly communicate with a remote processing 1130 unit, such as a computing device, a server, a host etc., of which the processing unit receives captured images to process these, and sends the authentication output via the communication unit 1140 to the display screen 1150. The processor 1130 may be composed of for example one or more general purpose microprocessors, application specific integrated arrays (ASIC), field programmable gate arrays (FPGA), graphical processing units (GPU), discreet logic circuit and, or any type of processing device suited to implement the method described herein.

In some embodiments, the processor may execute instructions (stored, e.g., in the memory 1120) for implementing the method described herein. The memory 1120 may store information and may be, for example, composed of one or more units, such as an image storage unit to store the captured image(s), an algorithm storage unit to store the algorithm described herein, an instruction storage unit to store the instruction for implementing the methods described herein etc. In some embodiments the training data and the pretrained algorithm may be stored in the memory 1120. The memory 1120 may include multiple storage modules ranging from volatile to non-volatile storage options. Those storage modules may feature random access memory such as static RAM, and dynamic RAM, along with permanent storage forms like read-only memory and flash memory.

FIG. 12 illustrates an anti-counterfeiting detection system of authenticating a label that contains pattern according to embodiments. The system includes a mobile device 1210 that has a digital camera 1220 and a display screen 1230. The display screen may be associated with a user interface to provide the user with a guide through the authentication process. For example, a button to start the authentication process and a bounding box to outline the label to capture the image may be presented. The image may then be sent to the processing unit 1240 to be processed. In some embodiments, the processing unit may be in a remote location and configured to receive the image from the mobile phone. The processing unit may then extract pattern features, evaluate the image (e.g. extracted pattern features, preprocessed image) using the trained algorithm, and send the output back to the mobile device 1210, where the results are displayed via the display screen of the mobile device 1230.

1. A method for anti-counterfeiting detection comprising:
receiving a digital image of a label from an image capturing device;
extracting features of one or more patterns comprised by the digital image;
applying a trained pattern recognition algorithm to decipher the one or more patterns in the label; and
returning an authenticity of the label.

2. The method of claim 1 further comprising preprocessing the digital image before extracting features.

3. The method of claim 2, wherein preprocessing comprises at least one of image standardizing, image color space transformation, image contrast enhancement, image spatial transformation, image segmentation and image refinement of the digital image.

4. The method of claim 1, wherein the features of the one or more patterns comprise at least one of edge properties, textural properties, frequency properties, and line properties.

5. The method of claim 1, wherein extracting features comprises at least one of dividing the digital images into image patches, applying one or more filters to extract the features, reducing the size or dimensions of the filtered patch images, generating an encoded matric with informative pattern features, and concatenating the encoded matrix with the image features matrix as input for the trained pattern recognition algorithm.

6. The method of claim 1, wherein the pattern recognition algorithm is obtained via training a comprehensive original deep learning model for deciphering the one or more patterns, wherein the comprehensive original model is further used to train a compressed deep learning model to mimic the behavior of the original model for deciphering the one or more patterns.

7. The method of claim 1, wherein the pattern recognition algorithm is obtained via a dual stage deep learning pipeline by:
training a first model to generate training data;
refining the generated training data; and
training a second model with the refined generated training data for deciphering the one or more patterns.

8. A system for anti-counterfeiting detection comprising:
an image capturing device configured to capture a digital image of a label;
a processor connected to the image capturing device, wherein the processor is configured to:
receive a digital image of a label from the image capturing device;
extract features of one or more patterns comprised by the digital image;
apply a trained pattern recognition algorithm to decipher the one or more patterns in the label; and
return an authenticity of the label.

9. The system of claim 8, wherein the processor is further configured to preprocess the digital image before extracting features.

10. The system of claim 9, wherein the processor is configured to preprocess the digital image by at least one of image standardizing, image color space transformation, image contrast enhancement, image spatial transformation, image segmentation and image refinement of the digital image.

11. The system of claim 8, wherein the features of the one or more patterns comprise at least one of edge properties, textural properties, frequency properties, and line properties.

12. The system of claim 8, wherein the processor is configured to extract features by at least one of dividing the digital images into image patches, applying one or more filters to extract the features, reducing the size or dimensions of the filtered patch images, generating an encoded matric with informative pattern features, and concatenating the encoded matrix with the image features matrix as input for the trained pattern recognition algorithm.

13. The system of claim 8, wherein the pattern recognition algorithm is obtained via training a comprehensive original deep learning model for deciphering the one or more patterns, wherein the comprehensive original model is further used to train a compressed deep learning model to mimic the behavior of the original model for deciphering the one or more patterns.

14. The system of claim 8, wherein the pattern recognition algorithm is obtained via a dual stage deep learning pipeline by:
training a first model to generate training data;
refining the generated training data; and
training a second model with the refined generated training data for deciphering the one or more patterns.

15. A computer program product comprising computer-executable instructions that are stored on a non-transitory computer-readable medium and that, when executed by a processor, cause the processor to:
receive a digital image of a label from the image capturing device;
extract features of one or more patterns comprised by the digital image;
apply a trained pattern recognition algorithm to decipher the one or more patterns in the label; and
return an authenticity of the label.
